(19) United States
(12) Patent Application Publication
(10) Pub. No.: US 2012/0243829 A1
(43) Pub. Date: Sep. 27, 2012

(54) Multi-diameter optical fiber link for transmitting unidirectional signals and eliminating signal deterioration

(75) Inventor: John Lynn, Easton, PA (US)

(73) Assignee: Netgami System LLC., Marganville, NJ (US)

(21) Appl. No.: 13/067,037

(22) Filed: May 4, 2011

(30) Foreign Application Priority Data
Mar. 24, 2011 (TW) 100110061

(51) Int. Cl. G02B 6/26

(52) U.S. Cl. 385/50

(57) ABSTRACT

The present invention is to provide a multi-diameter optical fiber link, which includes a first cable and a second cable connected in series with the first cable through an adaptor (or adaptors) and is characterized in that a first optical fiber enclosed in the first cable has a smaller diameter than a second optical fiber enclosed in the second cable. Hence, when the first and second cables are connected in series, an end surface of the first optical fiber is easily and precisely aligned within an end surface of the second optical fiber, thus allowing the second optical fiber to receive all optical signals transmitted from the first optical fiber. Consequently, the optical signals pass through the first and second optical fibers in succession, and a unidirectional signal transmission is realized in the multi-diameter optical fiber link without signal deterioration which may otherwise result from misalignment of the optical fibers.

### FIELD OF THE INVENTION

The present invention relates to an optical fiber link, more particularly to a multi-diameter optical fiber link for transmitting unidirectional signals and eliminating signal deterioration.

### BACKGROUND OF THE INVENTION

Optical fibers are glass or plastic fibers designed to transmit optical signals via total reflection of light within each fiber. Referring to FIG. 1, a thin optical fiber 11 is surrounded by and enclosed in a plastic sheath 12 to form a cable 10, wherein the resilience and mechanical strength of the plastic sheath 12 allow the optical fiber 11 to bend without breaking. After an end surface of the optical fiber 11 receives an optical signal generated by an optical signal transmitting chip 13 (e.g., a laser diode), the optical signal travels along the optical fiber 11 and finally reaches an opposite end surface thereof, so as for an optical signal receiving chip 14 (e.g., a photo diode) connected to the latter end surface of the optical fiber 11 to receive the optical signal transmitted from the optical signal transmitting chip 13. As the transmission loss of optical signals in the optical fiber 11 is far lower than the conduction loss of electricity in an electrical wire, and the optical fiber 11 is made mainly of silicon, which is abundant in reserves and can be easily mined, there is a trend to use the optical fiber 11 as a means for long-distance signal transmission. In addition, with the continuous progress in the manufacturing techniques of the optical fiber 11, not only has the transmission quality of the optical fiber 11 significantly improved, but also the price of the optical fiber 11 is gradually lowered, making it possible to use the optical fiber 11 in various consumer electronics (e.g., electronic audio/video devices for entertainment, medical electronic equipment, and computers and mobile phones for general use) as an ideal tool for transmitting large audio and video streams at high speed.

Generally speaking, an optical fiber is a duplex structure composed of a core and a cladding, wherein the core is made of a glass material having a relatively high refractive index, and the cladding is made of a glass or plastic material having a relatively low refractive index. The principle of signal transmission by an optical fiber is briefly stated as follows. First of all, the core is where optical signals are transmitted. While an optical signal travels along the core, the optical signal undergoes total reflection at the interface between the core and the cladding; as a result, the optical signal moves forward along a zigzag path. Since an optical fiber is thinner than a human hair, highly sophisticated and advanced manufacturing and quality control techniques are required to make such a delicate structure with materials of two different refractive indices. Recently, thanks to long-term efforts of scientists around the world, the transmission efficiency of optical fibers has increased substantially. An optical fiber featuring high transmission efficiency has a transmission loss as low as 0.2 decibel (dB) per kilometer; in other words, only 4.5% of the power of an optical signal is lost in each kilometer traveled. Therefore, these optical fibers are very suitable for transmitting signals over long distances. Besides, optical fibers can be divided into the following two types based on the diameters of their cores:

(1) Multi-mode optical fibers 11: Referring to FIG. 2, the core 110 of a multi-mode optical fiber 11 has a large diameter (larger than 10 micron), and the physical properties of the core 110 can be analyzed using geometric optics. When the multi-mode optical fiber 11 is used in telecommunication, it is typically surrounded by an orange cable jacket for easy identification. Inside the multi-mode optical fiber 11, an optical signal is transmitted along the core 110 via total reflection. More specifically, whenever the optical signal reaches the boundary between the core 110 and the cladding 111 with an incident angle greater than a critical angle, total reflection of the optical signal takes place, wherein the critical angle is determined jointly by the refractive index of the core 110 and the refractive index of the cladding 111.

(2) Single-mode optical fibers 21: Referring to FIG. 3, the core 210 of a single-mode optical fiber 21 has a diameter less than about ten times the wavelength of the propagating light wave. Moreover, the physical properties of the core 210 cannot be analyzed using geometric optics; instead, Maxwell's equations must be employed to produce the related electromagnetic wave equations. When used in telecommunication, the single-mode optical fiber 21 has a yellow cable jacket for easy identification. More importantly, a considerable portion of the power of an optical signal travelling along the single-mode optical fiber 21 is transmitted through the cladding 211 in the form of distorted waves.

Referring again to FIG. 1, optical signals transmitted through the optical fiber 11 attenuate as the transmission distance increases. Signal attenuation also results from the scattering and absorption of optical signals. Taking the currently available, highly transparent optical fiber 11 for example, the distortion coefficient of the fiber—represented in decibel per kilometer of medium—is usually less than 1 dB/km. While signal distortion over a short distance is only nominal, the accumulated distortion over a long distance can be detrimental to the quality of optical signal transmission. Now that attenuation is a major factor that hinders the transmission of optical signals over long distances, it is an important issue in the optical fiber industry to reduce signal attenuation. Apart from that, a cable adaptor is typically used to connect two cables 10 in series so that the corresponding end surfaces of the optical fibers 11 therein are aligned with each other along the same axis. However, as previously mentioned, the diameter of the optical fibers 11 is smaller than that of a human hair, so the precision with which the cable adaptor is designed and made also has a decisive impact on the quality of optical signal transmission.

Misalignment between the optical fibers in two connected optical fiber cables is discussed in more detail below with reference to three cases of misalignment in which the optical fibers are not properly aligned on the same axis. It should be noted that the drawings referred to in the following description only show the misaligned optical fibers after each pair of cables are connected in series by a cable adaptor.

(1) Lateral misalignment: Referring to FIG. 4, after the cables are connected in series by a cable adaptor, the corresponding end surfaces of the optical fibers 31 and 32 in the cables are laterally offset from each other such that a lateral gap a is formed. The lateral gap a becomes a transmission barrier to some of the optical signals that are transmitted via the optical fiber 31 in the transmitting-end cable; in other words, the affected signals will not be transmitted to the optical fiber 32 in the receiving-end cable. Consequently, the optical signals received by the optical signal receiving chip are seriously distorted.

(2) Longitudinal misalignment: Referring to FIG. 5, after the cables are connected in series by a cable adaptor, the corresponding end surfaces of the optical fibers 41 and 42 in the cables are longitudinally misaligned and spaced apart by a longitudinal gap b. As a result, some of the optical signals that are transmitted via the optical fiber 41 in the transmitting-end cable are lost in the longitudinal gap b and therefore fail to reach the optical fiber 42 in the receiving-end cable. This leads to significant distortion of the optical signals received by the optical signal receiving chip.

(3) Angular misalignment: Referring to FIG. 6, after the cables are connected in series by a cable adaptor, the corresponding end surfaces of the optical fibers 51 and 52 in the cables are angularly offset from each other and spaced apart by an angular gap c. In consequence, some of the optical signals that are transmitted via the optical fiber 51 in the transmitting-end cable are lost in the angular gap c and are not transmitted to the optical fiber 52 in the receiving-end cable. This also causes serious distortion to the optical signals received by the optical signal receiving chip.

In view of the above, the cable adaptor industry has devised the ceramic ferrules that are made of expensive ceramic materials using high-precision ceramic manufacturing techniques. The dimensions of the ceramic ferrules can be controlled with precision to ensure that, once two optical fiber cables are connected in series by such a ferrule, the optical fibers in the cables are precisely aligned along the same axis and safe from any of the aforesaid misalignment scenarios. This approach, however, significantly increases the manufacturing cost and complexity of cable adaptors, which prevents the ceramic ferrules from general application to consumer electronic products as a device that assists in high-speed transmission of large audio/video streams. Furthermore, should the manufacture or assembly of such ceramic ferrules be defective, cables connected thereby will still suffer from the aforesaid misalignment problems in which the optical fibers are not properly aligned along the same axis.

Therefore, the issue to be addressed by the present invention is to design a novel optical fiber link that is easy to make, has a low production cost, and can be readily implemented in consumer electronics so that, when two optical fiber cables are connected in series by a cable adaptor, optical signals traveling through the optical fibers in the transmitting-end cable can be transmitted unidirectionally and completely to the optical fibers in the receiving-end cable without signal deterioration, regardless of whether the optical fibers in the two cables are precisely aligned along the same axis, thereby effectively precluding the problem of optical signal distortion.

### BRIEF SUMMARY OF THE INVENTION

In consideration of the aforementioned drawbacks of the prior art, the inventor of the present invention put years of practical experience into extensive experiments and repeated trials and finally succeeded in developing a multi-diameter optical fiber link for transmitting unidirectional signals and eliminating signal deterioration.

It is an object of the present invention to provide a multi-diameter optical fiber link for transmitting unidirectional signals and eliminating signal deterioration, wherein the multi-diameter optical fiber link includes a first cable and a second cable. The first cable encloses a first optical fiber therein, wherein the first optical fiber has a first end surface for receiving optical signals and transmitting the optical signals to a second end surface of the first optical fiber. A second end of the first cable that corresponds in position to the second end surface of the first optical fiber is peripherally and fixedly provided with a first adaptor. The second cable encloses a second optical fiber therein, wherein the second optical fiber has a first end surface for receiving optical signals and transmitting the optical signals to a second end surface of the second optical fiber. A first end of the second cable that corresponds in position to the first end surface of the second optical fiber is peripherally and fixedly provided with a second adaptor. The second adaptor corresponds in configuration to and is engageable with the first adaptor so as to connect the first cable and the second cable in series. The multi-diameter optical fiber link is characterized in that the first optical fiber has a smaller diameter than the second optical fiber. Hence, when the first adaptor and the second adaptor are engaged with each other and thereby bring the first cable and the second cable into series connection, the second end surface of the first optical fiber is easily and precisely aligned with and located within the first end surface of the second optical fiber, thus allowing the first end surface of the second optical fiber to receive all the optical signals transmitted from the second end surface of the first optical fiber. Consequently, the optical signals pass through the first optical fiber and the second optical fiber in succession, and unidirectional signal transmission is realized without signal deterioration which may otherwise result from misalignment of the optical fibers. The multi-diameter optical fiber link not only is capable of unidirectional and distortion-free signal transmission, but also allows manufacturers to use a relatively low-precision plastic injection molding process to form low-cost plastic adaptors on the cables rapidly, so as to reduce the production cost and complexity of the resultant multi-diameter optical fiber link significantly while still ensuring that the multi-diameter optical fiber link is effective in eliminating signal loss and signal deterioration.

Another object of the present invention is to provide a multi-diameter optical fiber link for transmitting unidirectional signals and eliminating signal deterioration, wherein the multi-diameter optical fiber link is applicable to an electronic device as a short-distance unidirectional optical link within the electronic device. The multi-diameter optical fiber link includes a first cable and a second cable. The first cable encloses a first optical fiber therein. The first optical fiber has a first end surface connected to an optical signal transmitting chip (e.g., a laser diode) of the electronic device. The first end surface of the first optical fiber can receive optical signals transmitted from the optical signal transmitting chip and transmit the optical signals to a second end surface of the first optical fiber. The first cable has a second end which corresponds in position to the second end surface of the first optical fiber and which is peripherally and fixedly provided with a first adaptor (e.g., a male adaptor or a female adaptor). The second cable encloses a second optical fiber therein. The second optical fiber has a first end surface for receiving optical signals and transmitting the optical signals to an optical signal receiving chip (e.g., a photo diode) connected to a second end surface of the second optical fiber. The second cable has a first end which corresponds in position to the first end surface of the second optical fiber and which is peripherally and fixedly provided with a second adaptor. The second adaptor corresponds in configuration to and is engageable with the first adaptor so as to connect the second cable and the first cable in series. The multi-diameter optical fiber link is characterized in that the first optical fiber has a smaller diameter than the second optical fiber. Therefore, when the first adaptor and the second adaptor are engaged with each other to connect the first cable and the second cable in series, the second end surface of the first optical fiber can be easily and precisely aligned with and located within the first end surface of the second optical fiber. Thus, not only is the tolerance of alignment between the first optical fiber and the second optical fiber increased, but also the first end surface of the second optical fiber will receive all the optical signals transmitted from the second end surface of the first optical fiber. While the optical signals pass sequentially through the first optical fiber and the second optical fiber, unidirectional signal transmission is achieved. Furthermore, signal deterioration which may otherwise result from misalignment of the optical fibers is eliminated.

It is yet another object of the present invention to provide the foregoing multi-diameter optical fiber links, wherein the first end surface of the second optical fiber is larger in area than the second end surface of the first optical fiber by at least 10% to ensure that the second end surface of the first optical fiber can be easily and precisely aligned with and located within the first end surface of the second optical fiber.

It is still another object of the present invention to provide the foregoing multi-diameter optical fiber links, wherein the first end surface of the second optical fiber is larger in area than the second end surface of the first optical fiber by at least 20% to ensure that the adaptors have large tolerances. The large tolerances make it feasible for manufacturers to make low-cost plastic adaptors rapidly using a relatively low-precision plastic injection molding process, with a view to substantially reducing the production cost and complexity of the resultant multi-diameter optical fiber links while still ensuring that the second end surface of the first optical fiber can be easily and precisely aligned with and located within the first end surface of the second optical fiber. Hence, when the multi-diameter optical fiber links transmit unidirectional optical signals, both signal loss and signal deterioration are prevented.

Another object of the present invention is to provide a multi-diameter optical fiber link for transmitting unidirectional signals and eliminating signal deterioration, wherein the multi-diameter optical fiber link is configured for use as a long-distance unidirectional optical link between two electronic devices. The multi-diameter optical fiber link includes a first cable, a third cable, and a second cable, wherein the third cable has a greater length than the first cable and the second cable. The first cable encloses a first optical fiber therein. The first optical fiber has a first end surface connected to an optical signal transmitting chip (e.g., a laser diode) of a first electronic device. The first end surface of the first optical fiber can receive optical signals transmitted from the optical signal transmitting chip and transmit the optical signals to a second end surface of the first optical fiber. The first cable has a second end which corresponds in position to the second end surface of the first optical fiber and which is peripherally and fixedly provided with a first adaptor (e.g., a male adaptor or a female adaptor). The third cable encloses a third optical cable therein. The third optical fiber has a first end surface for receiving optical signals and transmitting the optical signals to a second end surface of the third optical fiber. The third cable has a first end which corresponds in position to the first end surface of the third optical fiber and which is peripherally and fixedly provided with a third adaptor (e.g., a female adaptor or a male adaptor). The third cable also has a second end which corresponds in position to the second end surface of the third optical fiber and which is peripherally and fixedly provided with a fourth adaptor (e.g., a female adaptor or a male adaptor). The third adaptor corresponds in configuration to and is engageable with the first adaptor so as to connect the third cable and the first cable in series. The second cable encloses a second optical fiber therein. The second optical fiber has a first end surface for receiving optical signals and transmitting the optical signals to an optical signal receiving chip (e.g., a photo diode) of a second electronic device, wherein the optical signal receiving chip is connected to a second end surface of the second optical fiber. The second cable has a first end which corresponds in position to the first end surface of the second optical fiber and which is peripherally and fixedly provided with a second adaptor (e.g., a male adaptor or a female adaptor). The second adaptor corresponds in configuration to and is engageable with the fourth adaptor so as to connect the second cable and the third cable in series. The multi-diameter optical fiber link is characterized in that the first optical fiber has a smaller diameter than the third optical fiber and that the third optical fiber has a smaller diameter than the second optical fiber. Hence, when the first cable, the third cable, and the second cable are connected in series in that order, the second end surface of the first optical fiber is easily and precisely aligned with and located within the first end surface of the third optical fiber, allowing the first end surface of the third optical fiber to receive all the optical signals transmitted from the second end surface of the first optical fiber, and the second end surface of the third optical fiber is easily and precisely aligned with and located within the first end surface of the second optical fiber, allowing the first end surface of the second optical fiber to receive all the optical signals transmitted from the second end surface of the third optical fiber without signal deterioration which may otherwise occur if the optical fibers are misaligned. Thus, optical signals generated by the optical signal transmitting chip of the first electronic device can pass through the first optical fiber, the third optical fiber, and the second optical fiber in turn and reach the optical signal receiving chip of the second electronic device, thereby realizing long-distance unidirectional transmission of the optical signals.

Still another object of the present invention is to provide the multi-diameter optical fiber link described in the previous paragraph, wherein the first end surface of the third optical fiber is larger in area than the second end surface of the first optical fiber by at least 10%, and the first end surface of the second optical fiber is larger in area than the second end surface of the third optical fiber at least by 10%. Thus, it is ensured that the second end surface of the first optical fiber can be easily and precisely aligned with and located within the first end surface of the third optical fiber and that the second end surface of the third optical fiber can be easily and precisely aligned with and located within the first end surface of the second optical fiber.

It is still another object of the present invention to provide the multi-diameter optical fiber link described in the paragraph before the last, wherein the first end surface of the third optical fiber is larger in area than the second end surface of the first optical fiber by at least 20%, and the first end surface of the second optical fiber is larger in area than the second end surface of the third optical fiber at least by 20%, so as to ensure that the adaptors have large tolerances. The large tolerances make it feasible for manufacturers to make low-cost plastic adaptors rapidly using a relatively low-precision plastic injection molding process, with a view to substantially reducing the production cost and complexity of the resultant multi-diameter optical fiber link while still ensuring that the multi-diameter optical fiber link is capable of long-distance unidirectional transmission of optical signals without signal deterioration during transmission.

### BRIEF DESCRIPTION OF THE SEVERAL VIEWS OF THE DRAWINGS

A detailed description of further features and advantages of the present invention is given below with reference to the accompanying drawings, in which:

FIG. 1 is a schematic drawing of a conventional optical fiber link;

FIG. 2 is a longitudinal sectional view of a conventional multi-mode optical fiber;

FIG. 3 is a longitudinal sectional view of a conventional single-mode optical fiber;

FIG. 4 is a longitudinal sectional view of two laterally misaligned optical fibers in the prior art;

FIG. 5 is a longitudinal sectional view of two longitudinally misaligned optical fibers in the prior art;

FIG. 6 is a longitudinal sectional view of two angularly misaligned optical fibers in the prior art;

FIG. 7 schematically shows the structure of a multi-diameter optical fiber link for transmitting unidirectional signals and eliminating signal deterioration according to the first to the third preferred embodiments of the present invention;

FIG. 8 schematically shows the structure of a multi-diameter optical fiber link for transmitting unidirectional signals and eliminating signal deterioration according to the fourth to the sixth preferred embodiments of the present invention; and

FIG. 9 schematically shows the structure of a multi-diameter optical fiber link for transmitting unidirectional signals and eliminating signal deterioration according to the seventh preferred embodiment of the present invention.

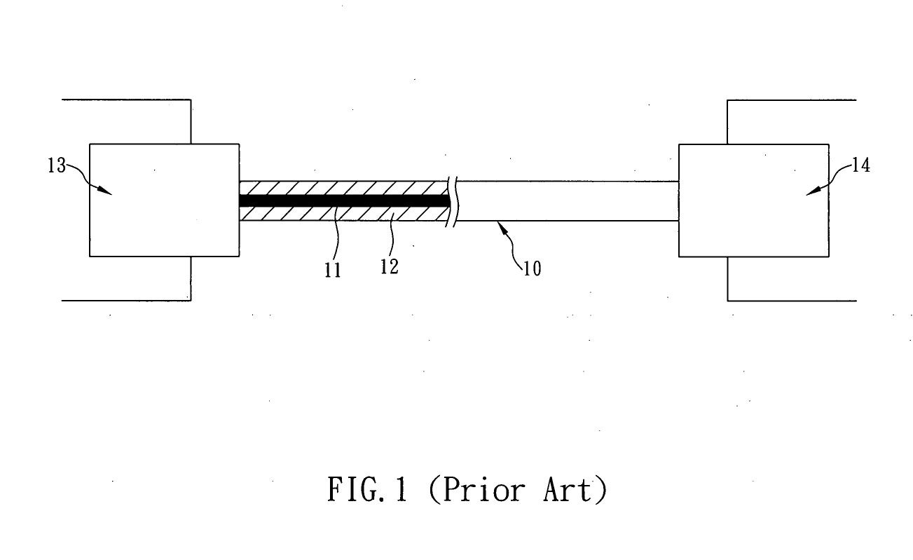

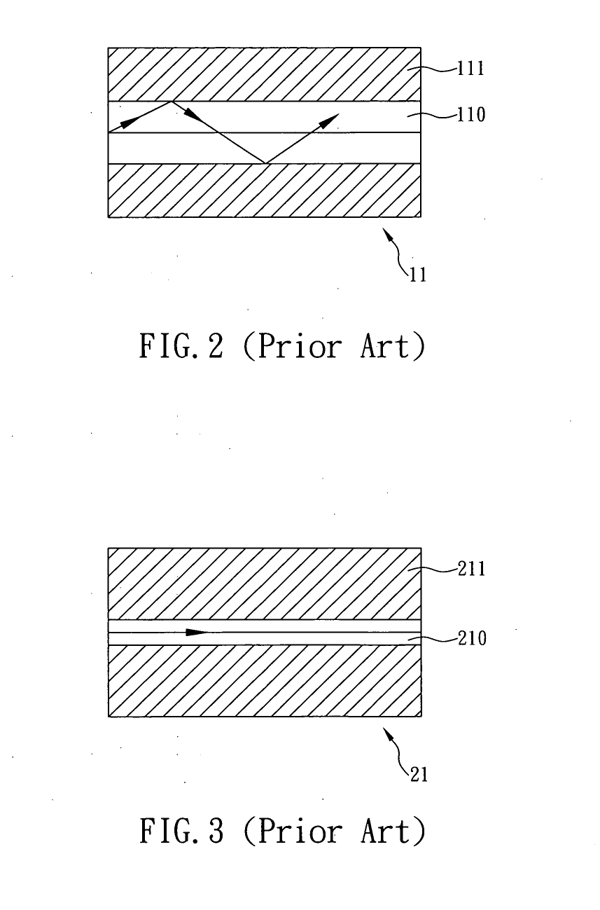

### DETAILED DESCRIPTION OF THE INVENTION

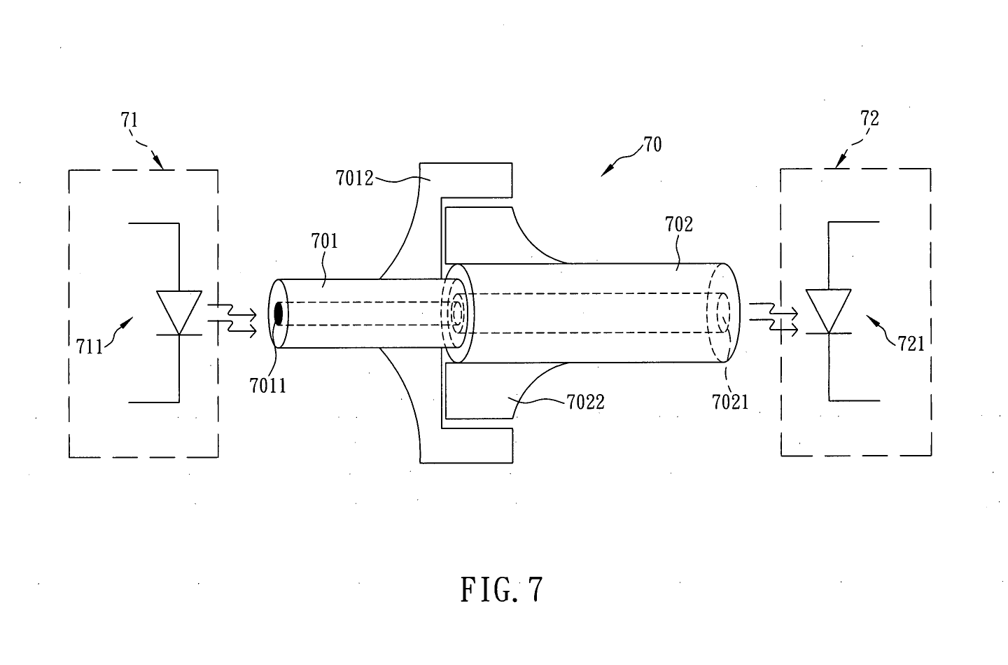

Referring to FIG. 7, the present invention provides a multi-diameter optical fiber link 70 for transmitting unidirectional signals and eliminating signal deterioration, wherein the multi-diameter optical fiber link 70 includes a first cable 701 and a second cable 702. The first cable 701 encloses a first optical fiber 7011 therein. The first optical fiber 7011 has a first end surface for receiving optical signals and transmitting the received optical signals to a second end surface of the first optical fiber 7011. The first cable 701 has a second end which corresponds in position to the second end surface of the first optical fiber 7011 and which is peripherally and fixedly provided with a first adaptor 7012. The second cable 702 encloses a second optical fiber 7021 therein. The second optical fiber 7021 has a first end surface for receiving optical signals and transmitting the received optical signals to a second end surface of the second optical fiber 7021. The second cable 702 has a first end which corresponds in position to the first end surface of the second optical fiber 7021 and which is peripherally and fixedly provided with a second adaptor 7022. The second adaptor 7022 corresponds in configuration to the first adaptor 7012 and can be engaged therewith to connect the second cable 702 and the first cable 701 in series. The multi-diameter optical fiber link 70 is characterized in that the first optical fiber 7011 has a smaller diameter than the second optical fiber 7021. Therefore, when the first adaptor 7012 and the second adaptor 7022 are engaged with each other and thereby connect the first cable 701 and the second cable 702 in series, the second end surface of the first optical fiber 7011 is easily and precisely aligned with and located within the first end surface of the second optical fiber 7021, so as for the first end surface of the second optical fiber 7021 to receive all the optical signals transmitted from the second end surface of the first optical fiber 7011, thus allowing the optical signals to pass sequentially through the first optical fiber 7011 and the second optical fiber 7021. Consequently, unidirectional transmission is accomplished without signal deterioration which may otherwise arise from misalignment of the optical fibers. The aforesaid design of the multi-diameter optical fiber link 70 also makes it feasible for manufacturers to form low-cost plastic adaptors on the cables rapidly using a relatively low-precision plastic injection molding process, thereby significantly reducing the production cost and complexity of the resultant multi-diameter optical fiber link while still ensuring that the multi-diameter optical fiber link can prevent signal loss and signal deterioration.

In the first preferred embodiment of the present invention as shown in FIG. 7, the multi-diameter optical fiber link 70 for transmitting unidirectional signals and eliminating signal deterioration is applied to an electronic device (e.g., a laptop computer, a mobile phone, or an audio/video player) and serves as a short-distance unidirectional optical link. The electronic device includes a master system 71 and a slave system 72, wherein the master system 71 is equivalent to a control circuit of the electronic device, and the slave system 72, to a display circuit of the electronic device. The master system 71 is configured to transmit large audio and video streams unidirectionally to the slave system 72 via the multi-diameter optical fiber link 70. In the first preferred embodiment, the master system 71 can convert the to-be-transmitted high-speed data signals into a format suitable for transmission over optical fibers. For example, the high-speed data signals are converted into optical signals by an optical signal transmitting chip 711 (e.g., a laser diode) in the master system 71; on the other hand, the slave system 72 is provided with an optical signal receiving chip 721 (e.g., a photo diode) for receiving the optical signals and converting the optical signals back, into the high-speed data signals. The multi-diameter optical fiber link 70 includes a first cable 701 and a second cable 702. The first cable 701 encloses a first optical fiber 7011 therein. The first optical fiber 7011 has a first end surface connected to the optical signal transmitting chip 711. The first end surface of the first optical fiber 7011 is configured to receive optical signals transmitted from the optical signal transmitting chip 711 and transmit the received optical signals to a second end surface of the first optical fiber 7011. The first cable 701 has a second end which corresponds in position to the second end surface of the first optical fiber 7011 and which is peripherally and fixedly provided with a first adaptor 7012 (e.g., the female adaptor shown in FIG. 7 or a male adaptor, depending on practical needs). The second cable 702 encloses a second optical fiber 7021 therein. The second optical fiber 7021 has a first end surface for receiving optical signals and transmitting the received optical signals to the optical signal receiving chip 721, which is connected to a second end surface of the second optical fiber 7021. The second cable 702 has a first end which corresponds in position to the first end surface of the second optical fiber 7021 and which is peripherally and fixedly provided with a second adaptor 7022 (e.g., the male adaptor shown in FIG. 7 or a female adaptor, depending on practical needs).

In the first preferred embodiment as shown in FIG. 7, the first adaptor 7012 corresponds in configuration to the second adaptor 7022 and is engageable therewith to connect the first cable 701 and the second cable 702 in series. Furthermore, the first optical fiber 7011 has a smaller diameter than the second optical fiber 7021 to ensure that the second end surface of the first optical fiber 7011 can be easily and precisely aligned with and located within the first end surface of the second optical fiber 7021. Thus, a large alignment tolerance is allowed between the first optical fiber 7011 and the second optical fiber 7021 to ensure that the first end surface of the second optical fiber 7021 receives all the optical signals transmitted from the second end surface of the first optical fiber 7011. When the first adaptor 7012 is engaged with the second adaptor 7022 and thereby connects the first cable 701 and the second cable 702 in series, optical signals generated by the optical signal transmitting chip 711 can pass sequentially through the first optical fiber 7011 and the second optical fiber 7021 and hence be transmitted unidirectionally to the optical signal receiving chip 721. As a result, not only are the optical signals transmitted unidirectionally from the optical signal transmitting chip 711 to the optical signal receiving chip 721 safe from signal deterioration, but also it is feasible to form low-cost plastic adaptors 7012 and 7022 rapidly on the cables 701 and 702 using a relatively low-precision plastic injection molding process, with a view to substantially reducing the production cost and complexity of the multi-diameter optical fiber link 70 while still ensuring that the multi-diameter optical fiber link 70 is effective in preventing signal loss and signal deterioration.

In the second preferred embodiment of the present invention as shown in FIG. 7, the first end surface of the second optical fiber 7021 is preferably larger in area than the second end surface of the first optical fiber 7011 by at least by 10% to guarantee a large alignment tolerance between the first optical fiber 7011 and the second optical fiber 7021. The large alignment tolerance allows the second end surface of the first optical fiber 7011 to be easily and precisely aligned with and located within the first end surface of the second optical fiber 7021 for unidirectional transmission, thereby eliminating signal deterioration which may otherwise result from misalignment between the optical fibers.

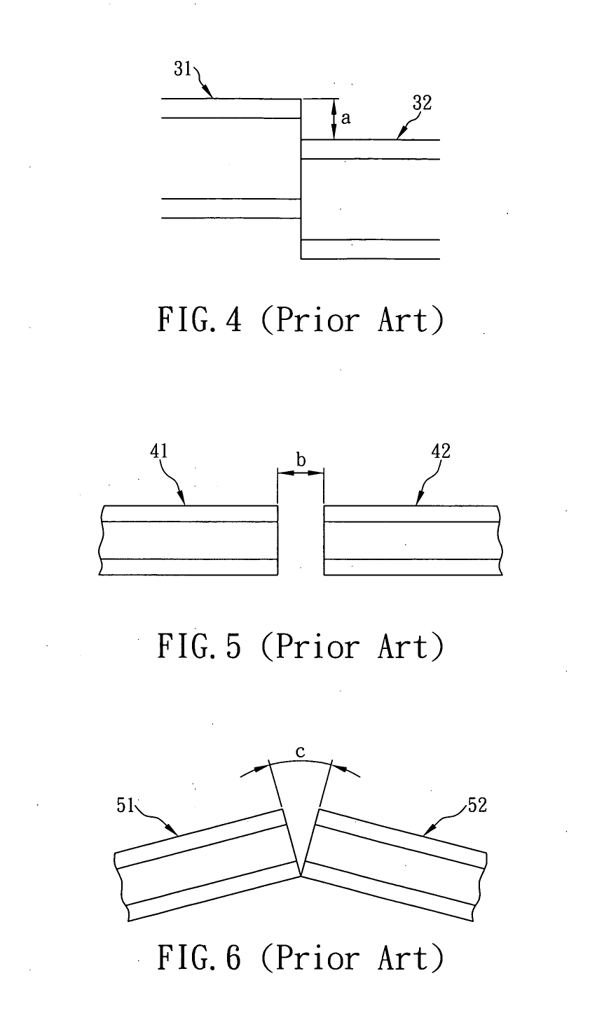

In the third preferred embodiment of the present invention as shown in FIG. 7, the first end surface of the second optical fiber 7021 is preferably larger in area than the second end surface of the first optical fiber 7011 by at least by 20% so that the adaptors 7012 and 7022 have large tolerances. The large tolerances make it feasible for manufacturers to make low-cost plastic adaptors rapidly using a relatively low-precision plastic injection molding process, for the purpose of substantially lowering the production cost and complexity of the resultant multi-diameter optical fiber link while still allowing the second end surface of the first optical fiber 7011 to be easily and precisely aligned with and located within the first end surface of the second optical fiber 7021. Thus, the lateral gap a shown in FIG. 4 will not occur in the multi-diameter optical fiber link 70, or even if the longitudinal gap b or the angular gap c shown in FIGS. 5 and 6 takes place, optical signals travelling through the optical fiber 7011 in the transmitting-end cable 701 will be transmitted completely to the optical fiber 7021 in the receiving-end cable 702 in spite of the transmission barrier formed by the gap b or c. Consequently, optical signals received by the optical signal receiving chip 721 are free of distortion.

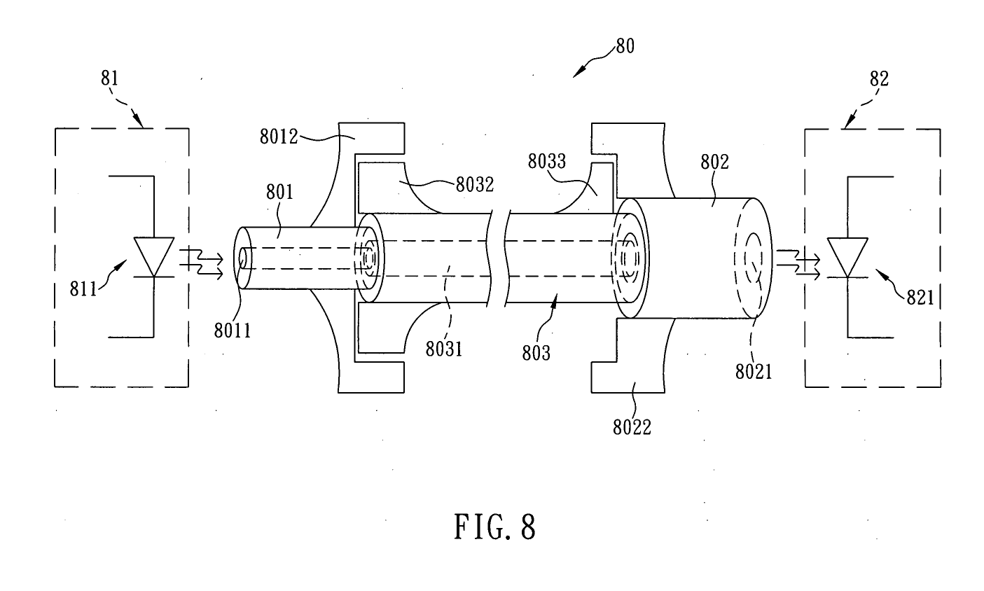

In the fourth preferred embodiment of the present invention as shown in FIG. 8, a multi-diameter optical fiber link 80 for transmitting unidirectional signals and eliminating signal deterioration is implemented as a long-distance unidirectional optical link between two electronic devices 81 and 82, wherein the first electronic device 81 can be a server, a web camera, a web gateway, and so on, and the second electronic device 82 can be a laptop computer, a desktop computer, a router, and so on. The first electronic device 81 is configured to transmit large audio and video streams to the second electronic device 82 unidirectionally by way of the multi-diameter optical fiber link 80. The first electronic device 81 can convert the to-be-transmitted high-speed data signals into a format suitable for transmission over optical fibers. More specifically, the high-speed data signals are converted into optical signals by an optical signal transmitting chip 811 in the first electronic device 81; on the other hand, the second electronic device 82 is provided with an optical signal receiving chip 821 for receiving the optical signals and converting the optical signals back into the high-speed data signals. The multi-diameter optical fiber link 80 includes a first cable 801, a third cable 803, and a second cable 802. The first cable 801 encloses a first optical fiber 8011 therein. The first optical fiber 8011 has a first end surface connected to the optical signal transmitting chip 811. The first end surface of the first optical fiber 8011 is configured to receive optical signals transmitted from the optical signal transmitting chip 811 and transmitting the received optical signals to a second end surface of the first optical fiber 8011. The first cable 801 has a second end which corresponds in position to the second end surface of the first optical fiber 8011 and which is peripherally and fixedly provided with a first adaptor 8012 (e.g., the female adaptor shown in FIG. 8 or a male adaptor, depending on practical needs). The third cable 803 encloses a third optical fiber 8031 therein. A first end and a second end of the third cable 803 are peripherally and fixedly provided with a third adaptor 8032 and a fourth adaptor 8033 (e.g., the male adaptors shown in FIG. 8 or female adaptors, depending on practical needs) respectively. The third optical fiber 8031 has a first end surface corresponding in position to the first end of the third cable 803 and a second end surface corresponding in position to the second end of the third cable 803. The first end surface of the third optical fiber 8031 is configured to receive optical signals and transmit the received optical signals to the second end surface of the third optical fiber 8031. The second cable 802 encloses a second optical fiber 8021 therein. The second optical fiber 8021 has a first end surface for receiving optical signals and transmitting the received optical signals to the optical signal receiving chip 821, which is connected to a second end surface of the second optical fiber 8021. The second cable 802 has a first end which corresponds in position to the first end surface of the second optical fiber 8021 and which is peripherally and fixedly provided with a second adaptor 8022 (e.g., the female adaptor shown in FIG. 8 or a male adaptor, depending on practical needs).

In the fourth preferred embodiment as shown in FIG. 8, the third adaptor 8032 at the first end of the third cable 803 corresponds in configuration to the first adaptor 8012 and can be engaged therewith to connect the third cable 803 and the first cable 801 in series. The first optical fiber 8011 has a smaller diameter than the third optical fiber 8031 to ensure that the second end surface of the first optical fiber 8011 can be easily and precisely aligned with and located within the first end surface of the third optical fiber 8031. Hence, a large alignment tolerance between the first optical fiber 8011 and the third optical fiber 8031 is provided to prevent signal deterioration attributable to misalignment between the optical fibers. It is also ensured that the first end surface of the third optical fiber 8031 receives all the optical signals transmitted from the second end surface of the first optical fiber 8011, before transmitting the received optical signals to the second end surface of the third optical fiber 8031. Likewise, the fourth adaptor 8033 at the second end of the third cable 803 corresponds in configuration to the second adaptor 8022 and is engageable therewith to connect the third cable 803 and the second cable 802 in series. The third optical fiber 8031 has a smaller diameter than the second optical fiber 8021 so that the second end surface of the third optical fiber 8031 can be easily and precisely aligned with and located within the first end surface of the second optical fiber 8021. Hence, a large alignment tolerance between the third optical fiber 8031 and the second optical fiber 8021 is provided to prevent signal deterioration attributable to misalignment between the optical fibers. It is also ensured that the first end surface of the second optical fiber 8021 receives all the optical signals transmitted from the second end surface of the third optical fiber 8031, before transmitting the received optical signals to the second end surface of the second optical fiber 8021. Therefore, once the first cable 801, the third cable 803, and the second cable 802 are connected in series, optical signals generated by the optical signal transmitting chip 811 can pass successively through the first optical fiber 8011, the third optical fiber 8031, and the second optical fiber 8021 and hence be transmitted unidirectionally to the optical signal receiving chip 821, thereby achieving distortion-free long-distance unidirectional transmission of the optical signals.

In the fifth preferred embodiment of the present invention as shown in FIG. 8, the first end surface of the third optical fiber 8031 is preferably larger in area than the second end surface of the first optical fiber 8011 by at least 10%, and the first end surface of the second optical fiber 8021 is preferably larger in area than the second end surface of the third optical fiber 8031 by at least 10%, so as to ensure a large alignment tolerance between the first optical fiber 8011 and the third optical fiber 8031 and between the third optical fiber 8031 and the second optical fiber 8021. The large alignment tolerances allow the second end surface of the first optical fiber 8011 to be easily and precisely aligned with and located within the first end surface of the third optical fiber 8031, and the second end surface of the third optical fiber 8031 to be easily and precisely aligned with and located within the first end surface of the second optical fiber 8021, thereby eliminating signal deterioration which may otherwise result from misalignment between the optical fibers.

In the sixth preferred embodiment of the present invention as shown in FIG. 8, the first end surface of the third optical fiber 8031 is preferably larger in area than the second end surface of the first optical fiber 8011 by at least 20%, and the first end surface of the second optical fiber 8021 is preferably larger in area than the second end surface of the third optical fiber 8031 by at least 20%, so as to ensure a large tolerance between the adaptors 8012 and 8032 and between the adaptors 8033 and 8022. The large tolerances make it feasible for manufacturers to make such adaptors rapidly by a relatively low-precision plastic injection molding process, with a view to significantly reducing the production cost and complexity of the resultant multi-diameter optical fiber link while still ensuring that the second end surface of the first optical fiber 8011 can be easily and precisely aligned with and located within the first end surface of the third optical fiber 8031 and that the second end surface of the third optical fiber 8031 can be easily and precisely aligned with and located within the first end surface of the second optical fiber 8021. In other words, the lateral gap a depicted in FIG. 4 is prevented from occurring between the first optical fiber 8011 and the third optical fiber 8031 or between the third optical fiber 8031 and the second optical fiber 8021. Even if the longitudinal gap b or the angular gap c shown in FIGS. 5 and 6 is formed, it is still ensured that optical signals transmitted along the optical fiber 8011 in the transmitting-end cable 801 will not be partially blocked from reaching the optical fiber 8021 in the receiving-end cable 802 by the transmission barrier created by the gap b or c. Consequently, optical signals received by the optical signal receiving chip 821 are free of distortion.

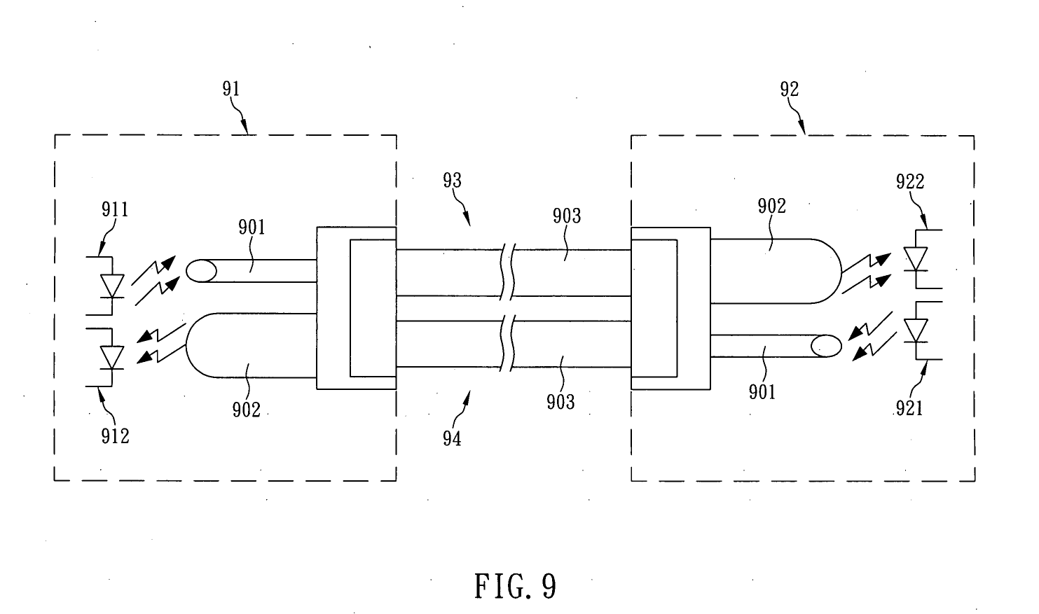

In the seventh preferred embodiment of the present invention as shown in FIG. 9, the disclosed multi-diameter optical fiber link is used between a computer 91 and a redundant array of independent disks (RAID) 92 to provide a long-distance bidirectional optical link. The computer 91 can convert to-be-transmitted data signals into a suitable format for transmission over optical fibers. For instance, the computer 91 is provided with a first optical signal transmitting chip 911 for converting the data signals into optical signals, and the optical signals are transmitted unidirectionally to a second optical signal receiving chip 922 in the RAID 92 by way of a first multi-diameter optical fiber link 93. Similarly, the RAID 92 can convert to-be-transmitted data signals into a suitable format for transmission over optical fibers. For instance, the RAID 92 is provided with a second optical signal transmitting chip 921 for converting the data signals into optical signals, which in turn are transmitted unidirectionally to a first optical signal receiving chip 912 in the computer 91 by way of a second multi-diameter optical fiber link 94. Thus, optical signals can be transmitted bidirectionally between the computer 91 and the RAID 92.

In the seventh preferred embodiment, each of the first and the second multi-diameter optical fiber links 93 and 94 includes a first cable, a third cable, and a second cable. To facilitate illustration, however, FIG. 9 only shows the aligned optical fibers inside the cables after the cables are sequentially connected in series by the corresponding adaptors. Each first cable encloses therein a first optical fiber 901 whose diameter is 50 μm (micron), each third cable encloses therein a third optical fiber 903 whose diameter is 62.5 μm, and each second cable encloses therein a second optical fiber 902 whose diameter is 100 μm. Each first optical fiber 901 has a first end surface connected to the first optical signal transmitting chip 911 or the second optical signal transmitting chip 921, and each second optical fiber 902 has a second end surface connected to the first optical signal receiving chip 912 or the second optical signal receiving chip 922. Thus, in either of the first and the second multi-diameter optical fiber links 93 and 94, it is ensured that a second end surface of the first optical fiber 901 is easily and precisely aligned with and located within a first end surface of the third optical fiber 903 and that a second end surface of the third optical fiber 903 is easily and precisely aligned with and located within a first end surface of the second optical fiber 902. In other words, the lateral gap a shown in FIG. 4 is unlikely to form between the first optical fiber 901 and the third optical fiber 903 or between the third optical fiber 903 and the second optical fiber 902, or even if the longitudinal gap b or the angular gap c shown in FIGS. 5 and 6 is formed, it is still ensured that optical signals transmitted through the optical fibers in the transmitting-end cables will be sent in full to the optical fibers in the receiving-end cables in spite of the transmission gap formed by the gap b or c. Consequently, not only is bidirectional transmission of optical signals achieved between the computer 91 and the RAID 92, but also the optical signals received by both the optical signal receiving chips 912 and 922 are prevented from distortion.

What is claimed is:

1. A multi-diameter optical fiber link for transmitting unidirectional signals and eliminating signal deterioration, the multi-diameter optical fiber link comprising a first cable and a second cable, the first cable enclosing a first optical fiber therein, the first optical fiber having a first end surface for receiving optical signals and transmitting the optical signals thus received to a second end surface of the first optical fiber, the first cable having a second end which corresponds in position to the second end surface of the first optical fiber and is peripherally and fixedly provided with a first adaptor, the second cable enclosing a second optical fiber therein, the second optical fiber having a first end surface for receiving optical signals and transmitting the optical signals thus received to a second end surface of the second optical fiber, the second cable having a first end which corresponds in position to the first end surface of the second optical fiber and is peripherally and fixedly provided with a second adaptor, the second adaptor corresponding in configuration to and being engageable with the first adaptor so as to connect the second cable and the first cable in series, the multi-diameter optical fiber link being characterized in that:
the first optical fiber has a smaller diameter than the second optical fiber so that, when the first adaptor and the second adaptor are engaged with each other and thereby connect the first cable and the second cable in series, the second end surface of the first optical fiber is aligned with and located within the first end surface of the second optical fiber, thus not only allowing the first end surface of the second optical fiber to receive all optical signals transmitted from the second end surface of the first optical fiber, but also allowing optical signals to pass sequentially through the first optical fiber and the second optical fiber and hence be transmitted unidirectionally.

2. The multi-diameter optical fiber link of claim 1, wherein the second optical fiber is larger in cross-sectional area than the first optical fiber by at least 10%.

3. The multi-diameter optical fiber link of claim 2, wherein the second optical fiber is larger in cross-sectional area than the first optical fiber by at least 20%.

4. The multi-diameter optical fiber link of claim 3, wherein the first adaptor is formed on the first cable by plastic injection molding, or the second adaptor is formed on the second cable by plastic injection molding.

5. A multi-diameter optical fiber link for transmitting unidirectional signals and eliminating signal deterioration, applicable to an electronic device comprising a master system and a slave system, wherein the master system is configured to convert data signals to be transmitted to the slave system into a format suitable for transmission over optical fibers, is provided with an optical signal transmitting chip for converting the data signals into optical signals, and is connected to the slave system by the multi-diameter optical fiber link, and the slave system is provided with an optical signal receiving chip for receiving the optical signals and converting the optical signals into the data signals, the multi-diameter optical fiber link comprising:
a first cable enclosing a first optical fiber therein, wherein the first optical fiber has a first end surface connected to the optical signal transmitting chip and configured to receive optical signals transmitted from the optical signal transmitting chip and transmit the optical signals thus received to a second end surface of the first optical fiber, the first cable having a second end which corresponds in position to the second end surface of the first optical fiber and is peripherally and fixedly provided with a first adaptor; and
a second cable enclosing a second optical fiber therein, the second cable having a first end peripherally and fixedly provided with a second adaptor, the second adaptor corresponding in configuration to and being engageable with the first adaptor so as to connect the second cable and the first cable in series, the second optical fiber having a first end surface which corresponds in position to the first end of the second cable and is configured to receive optical signals transmitted from the second end surface of the first optical fiber, the second optical fiber further having a second end surface connected to the optical signal receiving chip so as to transmit optical signals thereto, wherein the second optical fiber has a larger diameter than the first optical fiber to ensure that the second end surface of the first optical fiber is aligned with and located within the first end surface of the second optical fiber, thus not only allowing the first end surface of the second optical fiber to receive all optical signals transmitted from the second end surface of the first optical fiber, but also allowing optical signals to pass sequentially through the first optical fiber and the second optical fiber and hence be transmitted unidirectionally.

6. The multi-diameter optical fiber link of claim 5, wherein the second optical fiber is larger in cross-sectional area than the first optical fiber by at least 10%.

7. The multi-diameter optical fiber link of claim 6, wherein the second optical fiber is larger in cross-sectional area than the first optical fiber by at least 20%.

8. The multi-diameter optical fiber link of claim 7, wherein the first adaptor is formed on the first cable by plastic injection molding, or the second adaptor is formed on the second cable by plastic injection molding.

9. The multi-diameter optical fiber link of claim 8, wherein the master system is a control circuit of the electronic device, and the slave system is a display circuit of the electronic device.

10. A multi-diameter optical fiber link for transmitting unidirectional signals and eliminating signal deterioration, configured for use between a first electronic device and a second electronic device, wherein the first electronic device is connected to the second electronic device by the multi-diameter optical fiber link, is configured to convert data signals to be transmitted to the second electronic device into a format suitable for transmission over optical fibers, and is provided with an optical signal transmitting chip for converting the data signals into optical signals, and the second electronic device is provided with an optical signal receiving chip for receiving the optical signals and converting the optical signals into the data signals, the multi-diameter optical fiber link comprising:
a first cable enclosing a first optical fiber therein, wherein the first optical fiber has a first end surface connected to the optical signal transmitting chip and configured to receive optical signals transmitted therefrom and transmit the optical signals thus received to a second end surface of the first optical fiber, the first cable having a second end which corresponds in position to the second end surface of the first optical fiber and is peripherally and fixedly provided with a first adaptor;
a third cable enclosing a third optical fiber therein, wherein the third optical fiber has a first end surface for receiving optical signals and transmitting the optical signals thus received to a second end surface of the third optical fiber, the third cable having a first end which corresponds in position to the first end surface of the third optical fiber and is peripherally and fixedly provided with a third adaptor, the third cable further having a second end which corresponds in position to the second end surface of the third optical fiber and is peripherally and fixedly provided with a fourth adaptor, the third adaptor corresponding in configuration to and being engageable with the first adaptor so as to connect the third cable and the first cable in series, the third optical fiber having a larger diameter than the first optical fiber to ensure that the second end surface of the first optical fiber is aligned with and located within the first end surface of the third optical fiber, thus allowing the first end surface of the third optical fiber to receive all optical signals transmitted from the second end surface of the first optical fiber; and
a second cable enclosing a second optical fiber therein, wherein the second optical fiber has a first end surface for receiving optical signals and a second end surface connected to the optical signal receiving chip so as to transmit optical signals thereto, the second cable having a first end which corresponds in position to the first end surface of the second optical fiber and is peripherally and fixedly provided with a second adaptor, the second adaptor corresponding in configuration to and being engageable with the fourth adaptor at the second end of the third cable so as to connect the second cable and the third cable in series, the second optical fiber having a larger diameter than the third optical fiber to ensure that the second end surface of the third optical fiber is aligned with and located within the first end surface of the second optical fiber, thus allowing the first end surface of the second optical fiber to receive all optical signals transmitted from the second end surface of the third optical fiber.

11. The multi-diameter optical fiber link of claim 10, wherein the third optical fiber is larger in cross-sectional area than the first optical fiber by at least 10%.

12. The multi-diameter optical fiber link of claim 11, wherein the second optical fiber is larger in cross-sectional area than the third optical fiber by at least 10%.

13. The multi-diameter optical fiber link of claim 12, wherein the third optical fiber is larger in cross-sectional area than the first optical fiber by at least 20%.

14. The multi-diameter optical fiber link of claim 13, wherein the second optical fiber is larger in cross-sectional area than the third optical fiber by at least 20%.

15. The multi-diameter optical fiber link of claim 14, wherein the first adaptor is formed on the first cable by plastic injection molding, the third adaptor and the fourth adaptor are formed on the third cable by plastic injection molding, or the second adaptor is formed on the second cable by plastic injection molding.

16. The multi-diameter optical fiber link of claim 15, wherein the first electronic device is a server, a web camera, a redundant array of independent disks (RAID), or a web gateway.

17. The multi-diameter optical fiber link of claim 16, wherein the second electronic device is a laptop computer, a desktop computer, or a router.
